(19) United States
(12) Patent Application Publication
(10) Pub. No.: US 2024/0345040 A1
(43) Pub. Date: Oct. 17, 2024

(54) ION MOBILITY SPECTROMETER

(71) Applicant: G.A.S. Gesellschaft für analytische Sensorsysteme m.b.H., Dortmund (DE)

(72) Inventors: Andre GROSSE BLEY, Bochum (DE); Daniel SANDERS, Muehlheim an der Ruhr (DE); Cengiz SIRKECI, Bergkamen (DE)

(73) Assignee: G.A.S. Gesellschaft für analytische Sensorsysteme m.b.H., Dortmund (DE)

(21) Appl. No.: 18/682,491

(22) PCT Filed: Jun. 30, 2022
(86) PCT No.: PCT/EP2022/068189

§ 371 Date: Feb. 9, 2024

(30) Foreign Application Priority Data
Aug. 10, 2021 (DE) 10 2021 120 720.7

(51) Int. Cl. G01N 30/62; G01N 30/02

(52) U.S. Cl. CPC G01N 30/62; G01N 2030/025

(57) ABSTRACT

An ion mobility spectrometer has a tubular ionization chamber which includes a sample gas inlet and a gas outlet, an ionization device disposed inside the ionization chamber, and a tubular drift chamber which is separated from the ionization chamber by an ion shutter grid, the drift chamber having an ion detector and a drift gas inlet on the end remote from the ion shutter grid. The ionization device has a planar contact surface, which is oriented parallel and at a minimal distance from the ion shutter grid transversely to the longitudinal axis of the ionization chamber, the sample gas inlet having a sample gas feed line, the sample discharge end of which opens directly in the region of the contact surface of the ionization device.

The invention relates to an ion mobility spectrometer having a tubular ionization chamber that has a sample gas inlet and a gas outlet, and having an ionization device arranged within the ionization chamber, as well as having a tubular drift chamber, which is separated from the ionization chamber by means of an ion shutter grid, wherein the drift chamber has an ion detector and a drift gas inlet at the end facing away from the ion shutter grid, wherein the ionization device is arranged on the end face of a cylindrical flow body arranged in the ionization chamber.

Such ion mobility spectrometers (IMS) are presently designed for maximal ionization and thereby for great sensitivity. This is accompanied by a long dwell time of the sample in the ionization chamber of the ion mobility spectrometer. In the case of modern systems with preceding gas chromatography separation (GC), this unavoidably leads to broadening of the detected signals (abatement of flushing out from the ionization chamber of the ion mobility spectrometer, into which the substances separated in the gas chromatography separation column elute). This results in worsened gas chromatography separation. An ion mobility spectrometer having the characteristics of the preamble of claim 1 is known from U.S. Pat. No. 5,021,654 A.

It is the task of the invention to create an ion mobility spectrometer that ensures good gas chromatography resolution, in connection with gas chromatography pre-separation.

This task is accomplished, in the case of an ion mobility spectrometer of the type designated initially, according to the invention, in that the ionization device has a planar contact surface, which is oriented parallel to and at a slight distance from the ion shutter grid, transverse to the longitudinal axis of the ionization chamber, wherein the sample gas inlet has a sample gas feed line, the sample discharge end of which opens directly into the region of the contact surface of the ionization device.

By means of the sample feed directly or immediately into the ionization region of the ion mobility spectrometer, and by means of the drift gas feed brought about by means of the flow body, the dwell time of the eluted sample can be shortened or optimized in a targeted manner. With the shortening of the dwell time, good gas chromatography resolution can be ensured, so that the advantages of combining gas chromatography pre-separation and an ion mobility spectrometer fully come to bear.

In addition, targeted reduction of the sensitivity of the ion detector can be achieved at very high drift gas to sample gas ratios. This brings about flattening of the calibration curve (detected substance signal vs. concentration), so that the maximally detectable concentration range, which is determined in accordance with the IMS principle, can be clearly displaced upward. This saturation of the detector, i.e. its low dynamic range, often represents an application restriction in numerous analytical applications, and this is significantly improved by means of the invention.

The planar contact surface of the ionization device, which is arranged perpendicular to the drift tube, and the slight distance from the electronic ion shutter grid furthermore lead to an optimized IMS resolution. In combination with the improved GC resolution, it is therefore typically possible to analyze complex substance mixtures within a shorter measurement time or with an improved analytical resolution. This is advantageous for analytical measurement tasks.

Due to the design of the ion mobility spectrometer, there is furthermore no dead volume in the ionization device, and thereby no mixing of the molecules separated in the GC column, as the result of low-flow zones ahead of the ionization device. Direct removal of the ions in the electrical field and in the drift gas stream takes place, out of the area of action. Furthermore, forced ionization takes place, by means of flow over the active surface in the direction toward the gas outlet.

Particularly preferably, it is provided that a through-flow regulator (e.g. an electronic pressure controller) for regulating the corresponding volume stream is assigned to the sample gas inlet and the drift gas inlet, in each instance. In this way, the ion stream can be controlled by means of volume streams of sample gas and drift gas that can be regulated independently of one another. The size of the volume streams can be adjusted, for example, by way of the firmware of the ion mobility spectrometer.

In an embodiment that is preferred in terms of design, it is provided that the sample gas feed line is integrated into the flow body. Alternatively, the sample gas feed line can also be configured separately from the flow body.

In this regard, the sample gas feed line can preferably extend along the longitudinal axis of the ionization chamber.

Furthermore, it can be provided that the flow body is configured to narrow conically, proceeding from the ionization device.

In this regard, it can preferably additionally be provided that the tubular ionization chamber is configured to narrow conically toward the end that faces away from the ion shutter grid.

The invention also relates to a measurement device having an ion mobility spectrometer as described above and having gas chromatography pre-separation that is connected with the sample gas inlet of the ion mobility spectrometer.

The invention will be explained in greater detail below, as an example, using the drawing. This shows, in

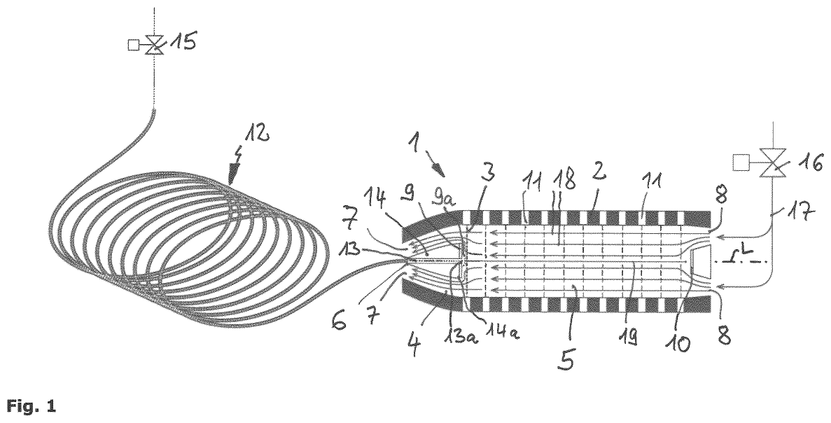

FIG. 1 a schematic sectional representation of an ion mobility spectrometer
according to a first embodiment, with gas chromatography pre-separation,

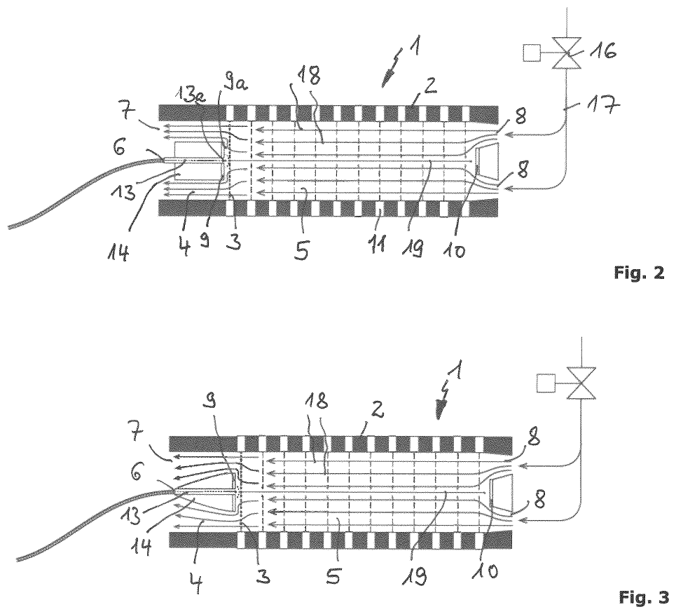

FIG. 2 a schematic sectional representation of an ion mobility spectrometer
according to a second embodiment,

FIG. 3 a schematic sectional representation of an ion mobility spectrometer
according to a third embodiment,

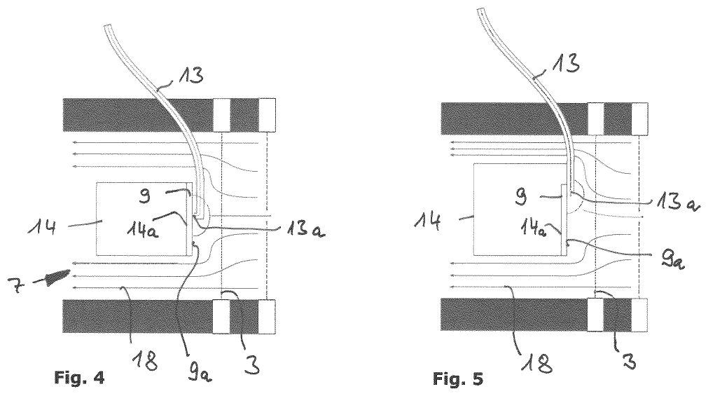

FIG. 4 an ionization chamber of an ion mobility spectrometer according to a
fourth embodiment, in a schematic sectional representation, and

FIG. 5 an ionization chamber of an ion mobility spectrometer according to
a fifth embodiment, in a schematic sectional representation.

An ion mobility spectrometer is indicated, in general, with 1. This ion mobility spectrometer 1 has a tubular housing 2, the longitudinal axis of which is indicated with L.

The interior of the tubular housing 2 is divided into a tubular ionization chamber 4 and a tubular drift chamber 5 by means of an ion shutter grid 3 that is arranged to lie transverse to the longitudinal axis L.

The ionization chamber 4 has a sample gas inlet 6 and a gas outlet 7; the drift chamber 5 has a drift gas inlet 8 on the end of the drift chamber 5 that lies opposite the ion shutter grid 3. Within the ionization chamber 4, an ionization device 9, for example a UV radiation source or a radioactive radiation source, is arranged.

At the end facing away from the ion shutter grid 3, the drift chamber 5 has an ion detector 10, which can consist, for example, of a Faraday plate and an aperture lattice arranged ahead of this Faraday plate. Along the drift line, in the drift chamber 5, a preferably homogeneous electrical field is built up during operation of the ion mobility spectrometer, and for this purpose, metal rings 11 integrated into the housing 2 and connected to a voltage source are provided.

The ion mobility spectrometer 1 described to this extent is fundamentally known, and according to the invention, it is now configured in the manner described in greater detail below, so as to be used as a measurement device, in particular together with gas chromatography pre-separation.

Such gas chromatography pre-separation is shown schematically in FIG. 1, in the form of a line that is wound in loop form and indicated with 12. This gas chromatography pre-separation 12 is connected to the sample gas inlet 6 of the ion mobility spectrometer 1.

The ionization device 9 is arranged on the end face 14a of a cylindrical flow body 14 arranged in the ionization chamber 4. In this regard, the ionization device 14 has a planar contact surface 14a, which is oriented at a slight distance from (approximately between 1 mm and 3 mm at an inside diameter of the ionization chamber of 15.2 mm) and parallel to the ion shutter grid 3, transverse to the longitudinal axis L of the ionization chamber 4. Furthermore, it is provided that the sample gas inlet 6 has a sample gas feed line 13, the sample gas discharge end 13a of which opens immediately or directly into the region of the contact surface 9a of the ionization device 9.

In the case of the embodiments shown in FIGS. 1 to 3, the sample gas feed line 13 is integrated into the flow body 14 and extends along the longitudinal axis L of the ionization chamber 4. The flow body 14 preferably has the longitudinal axis L as an axis of symmetry.

A through-flow regulator 15, 16 for regulating the corresponding volume stream of the sample gas or of the drift gas, respectively, is assigned to both the sample gas inlet 6 and the drift gas inlet 8, in each instance. In this regard, the preferably electronic through-flow regulator 15 is integrated into the corresponding feed line ahead of the gas chromatography pre-separation 12, viewed in the flow direction, and the preferably also electronic through-flow regulator 16 is integrated into the drift gas feed line 17, which opens into the drift gas inlet 8.

In the embodiment according to FIG. 1, the flow body 14 is configured to narrow conically, proceeding from the ionization device 9, just like the tubular ionization chamber 4 toward the end that faces away from the ion shutter grid 3. In this way, flow conditions occur that are represented by arrows 18 for the drift gas stream and an arrow 19 for the sample ion stream in the drift chamber 5.

In FIG. 2, a second embodiment of an ion mobility spectrometer 1 is shown, which differs from the one according to FIG. 1 only in that the geometrical shape of the ionization chamber 4 and of the flow body 14 is different; in this embodiment, both of them are configured to be cylindrical. The gas chromatography pre-separation 12 is not shown in FIG. 2.

The embodiment according to FIG. 3 differs from the one according to FIG. 1 only in that the ionization chamber 9 is configured to be cylindrical, and the flow body 14 is configured to narrow conically.

In the case of the fourth embodiment according to FIG. 4, the sample gas feed line is configured differently; it is not integrated into the flow body 14, but rather guided to lie essentially transverse to the longitudinal axis L, as a hose or the like, through the wall of the housing 2, into the center of the contact surface after the ionization device 9.

The embodiment of FIG. 5 differs from the one according to FIG. 4 only in that the ionization device 9 extends only partially beyond the end face 14a of the flow body 14, and the sample gas feed line 13 opens into the region of the contact surface 9a of the ionization device 9 at a slightly different location.

### REFERENCE SYMBOL LIST

1 ion mobility spectrometer
2 housing
3 ion shutter grid
4 ionization chamber
5 drift chamber
6 sample gas inlet
7 gas outlet
8 drift gas inlet
9 ionization device
9a contact surface
10 ion detector
11 metal rings
12 gas chromatography pre-separation
13 sample gas feed line
13a sample gas discharge end
14 flow body
14a end face
15 through-flow regulator
16 through-flow regulator
17 drift gas feed line
18 arrow
19 arrow
L longitudinal axis

1: An ion mobility spectrometer having a tubular ionization chamber (4) that has a sample gas inlet (6) and a gas outlet (7), and having an ionization device (8) arranged within the ionization chamber (4), as well as having a tubular drift chamber (5), which is separated from the ionization chamber (4) by means of an ion shutter grid (3), wherein the drift chamber (5) has an ion detector (10) and a drift gas inlet (8) at the end facing away from the ion shutter grid (3), wherein the ionization device (9) is arranged on the end face (14a) of a cylindrical flow body (14) arranged in the ionization chamber (4),
wherein
the ionization device (9) has a planar contact surface (9a), which is oriented parallel to and at a slight distance from the ion shutter grid (3), transverse to the longitudinal axis (L) of the ionization chamber (4), wherein the sample gas inlet (6) has a sample gas feed line (13), the sample discharge end (13a) of which opens directly into the region of the contact surface (9a) of the ionization device (9).

2: The ion mobility spectrometer according to claim 1,
wherein a through-flow regulator (15, 16) for regulating the volume stream, in each instance, is assigned to the sample gas inlet (6) and the drift gas inlet (8), in each instance.

3: The ion mobility spectrometer according to claim 1,
wherein the sample gas feed line (13) is integrated into the flow body (14).

4: The ion mobility spectrometer according to claim 3,
wherein the sample gas feed line (13) extends along the longitudinal axis (L) of the ionization chamber (14).

5: The ion mobility spectrometer according to claim 1, wherein the flow body (14) is configured to narrow conically, proceeding from the ionization device (9).

6: The ion mobility spectrometer according to claim 1, wherein the tubular ionization chamber (4) is configured to narrow conically toward the end that faces away from the ion shutter grid (3).

7: A measurement device having the ion mobility spectrometer (1) according to claim 1 and having gas chromatography pre-separation (12) connected with the sample gas inlet (6) of the ion mobility spectrometer (1).
